(19) United States
(12) Patent Application Publication
(10) Pub. No.: US 2026/0135040 A1
(43) Pub. Date: May 14, 2026

(54) METALLIZED FILM AND FILM CAPACITOR

(71) Applicant: SHIZUKI ELECTRIC COMPANY INC., Hyogo (JP)

(72) Inventors: Tsugunori MIYAZAKI, Hyogo (JP); Yasushi MAEHATA, Hyogo (JP); Yoshiyuki HIRAGAMI, Hyogo (JP); Kyosuke YOSHIDA, Hyogo (JP)

(73) Assignee: SHIZUKI ELECTRIC COMPANY INC., Hyogo (JP)

(21) Appl. No.: 19/118,038

(22) PCT Filed: Sep. 27, 2023
(86) PCT No.: PCT/JP2023/035105

§ 371 Date: Apr. 3, 2025

(30) Foreign Application Priority Data
Oct. 21, 2022 (JP) 2022-169439

(51) Int. Cl. H01G 4/255

(52) U.S. Cl. CPC H01G 4/255

(57) ABSTRACT

A metallized film obtained by vapor-depositing a metal on a dielectric film such that an insulating margin is formed on one end of the dielectric film in a width direction, includes a divided electrode and a fuse. The divided electrode formed by dividing a vapor-deposited metal on a side of the insulating margin by slit-shaped non-vapor-deposited portions. The fuse connected to the divided electrode, in which a plurality of the divided electrodes is arranged in the width direction of the dielectric film, and the divided electrodes corresponding to a first column and a second column as viewed from the insulating margin side satisfy all of the following conditions [1] to [3]. [1] An area is 15 mm² or more, [2] four or more of the fuses are connected, and [3] it is connected to all adjacent divided electrodes, each via one of the fuses.

### TECHNICAL FIELD

The present invention relates to a metallized film obtained by vapor-depositing a metal on a dielectric film, and a film capacitor using the metallized film.

### BACKGROUND ART

In a metallized film capacitor, when an insulation defect occurs, a current flows into a defect portion and a vapor-deposited metal generates heat and the vapor-deposited metal around the defect portion evaporates and scatters, causing self-healing for ensuring insulation (self-healing function). However, in order to cope with a large insulation defect that cannot be coped with by the self-healing, there is a case where a fuse mechanism is adopted in which a plurality of divided electrodes is formed by dividing the vapor-deposited metal by slit-shaped non-vapor-deposited portions and the divided electrodes are connected to each other by a fuse. That is, a mechanism is constructed in which the fuse is heated and fused using the current flowing from another divided electrode toward a divided electrode in which the insulation defect has occurred in order to cut off the defect portion together with the divided electrode (self-protecting function). Note that, recently, this fuse mechanism is mainly used.

Regarding capacitors that require strict safety, such as recent automobile capacitors (for example, inverter smoothing capacitors of electric vehicles and hybrid electric vehicles), fuses are designed to operate even for minor defects in order to ensure reliable insulation, and the defect portion is cut off together with the divided electrode regardless of the size of the defect. Here, as an index of ease of operation of the fuse, a “fuse operation rate” which is a ratio of the “number of divided electrodes cut off by fuse operation” to the “number of divided electrodes in which self-healing has occurred” is used, and the fuse operation rate is often set to approximately 100% (see, for example, Patent Literatures 1 and 2).

### Citations List

Patent Literature 1: JP 2019-207931 A
Patent Literature 2: JP 2020 025051 A

### SUMMARY OF INVENTION

### Technical Problems

In a design aiming at a high fuse operation rate, insulation can be reliably ensured, but when an insulation defect occurs, a divided electrode is almost certainly cut off, and the electrostatic capacitance decreases by the amount of the divided electrode that has been cut off.

In order to suppress the decrease in electrostatic capacitance, it is conceivable to divide a vapor-deposited metal into small portions and reduce the area of each divided electrode, but since the area of a non-vapor-deposited portion that divides the vapor-deposited metal increases, the effective electrode area decreases, and as a result, the initial capacitance of the entire capacitor is reduced.

Therefore, an object of the present invention is to provide a metallized film capable of suppressing excessive operation of a fuse.

### Solutions to Problems

In order to suppress the excessive operation of the fuse, first, it is necessary to control the heat generation amount of the vapor-deposited metal due to the current flowing toward the defect portion when the insulation defect occurs. Specifically, when the heat generation amount of the defect portion is large, the scale of self-healing increases. When the scale of self-healing is large, the amount of current flowing through the fuse increases, causing the heat generation amount of the fuse to increase. When the heat generation amount of the fuse is large, the fuse operation rate increases. As a result of intensive studies by the inventors, it has been found that the operation rate of the fuse can be suppressed to 10% or less if the heat generation amount of the fuse can be suppressed to 30% or less of the heat generation amount of the defect portion. In order to increase the heat generation amount of the defect portion without increasing the heat generation amount of the fuse, it is preferable that all or most of the electric energy required for self-healing is covered by the divided electrode itself in which the insulation defect has occurred.

In addition, the ease of operation of the fuse varies depending on the position where the insulation defect occurs. For example, since a large amount of current flows through a fuse which is close to the insulation defect, this fuse tends to be easily operated. In order to suppress the excessive operation of the fuse due to the positional variation of the insulation defect, it is desirable to dispose the fuses as evenly as possible on an outer periphery of the divided electrode.

A metallized film of the present invention is configured to satisfy these conditions. That is, a metallized film obtained by vapor-depositing a metal on a dielectric film 10 such that an insulating margin 40 is formed on one end of the dielectric film 10 in a width direction, includes: a divided electrode (23a, 23b) formed by dividing a vapor-deposited metal 20 on a side of the insulating margin 40 by slit-shaped non-vapor-deposited portions 41; and a fuse (24, 25, 26, 27) connected to the divided electrode, in which a plurality of the divided electrodes is arranged in the width direction of the dielectric film 10, and the divided electrodes corresponding to a first column and a second column as viewed from the insulating margin 40 side satisfy all of the following conditions [1] to [3].
[1] An area is 15 mm² or more.
[2] Four or more of the fuses are connected.
[3] It is connected to all adjacent divided electrodes, each via one of the fuses.

In addition, it is preferable that all of the divided electrodes satisfy all of the conditions [1] to [3].

A film capacitor of the present invention uses the metallized film 2 described above.

### Advantageous Effects of Invention

In the metallized film and the film capacitor of the present invention, by setting the area of each of the divided electrodes corresponding to the first column and the second column as viewed from the insulating margin 40 side to 15 mm² or more, all or most of the electric energy required for self-healing can be covered by the divided electrode itself in which the insulation defect has occurred, and the electric energy supplied from another divided electrode via the fuse can be eliminated or reduced. In addition, four or more fuses are connected to the divided electrode, and the divided electrode and all of the divided electrodes adjacent to the divided electrode are each connected via one fuse, so that the deviation of the positions where the fuses are provided is reduced. Therefore, even if an insulation defect occurs in any part of the divided electrode, it is possible to prevent electric energy required for self-healing from being intensively supplied from a specific fuse. As a result, excessive operation of the fuse can be suppressed.

### BRIEF DESCRIPTION OF DRAWINGS

FIG. 1 is a cross-sectional view illustrating a part of a film capacitor according to an embodiment of the present invention.

FIG. 2 is a plan view of a metallized film according to the embodiment of the present invention.

FIG. 3 is a plan view illustrating a metallized film of Comparative Example 1.

FIG. 4 is a graph indicating a V-T test (capacitance change rate).

FIG. 5A is graphs indicating results of a voltage step-up test which indicates a capacitance change rate with respect to a voltage.

FIG. 5B is graphs indicating results of a voltage step-up test which indicates a value of an insulation resistance with respect to the voltage.

FIG. 6 is a graph indicating a relationship between a heat generation amount of a fuse/a heat generation amount of a defect portion and a fuse operation rate.

FIG. 7 is a circuit diagram of a model used for calculating the heat generation amount of the fuse and the heat generation amount of the defect portion.

FIG. 8 is a graph indicating a relationship between capacitor performance (potential gradient) and an effective electrode area.

FIG. 9 is a plan view illustrating a metallized film of a modification.

FIG. 10 is a plan view illustrating a metallized film of another modification.

### DESCRIPTION OF EMBODIMENTS

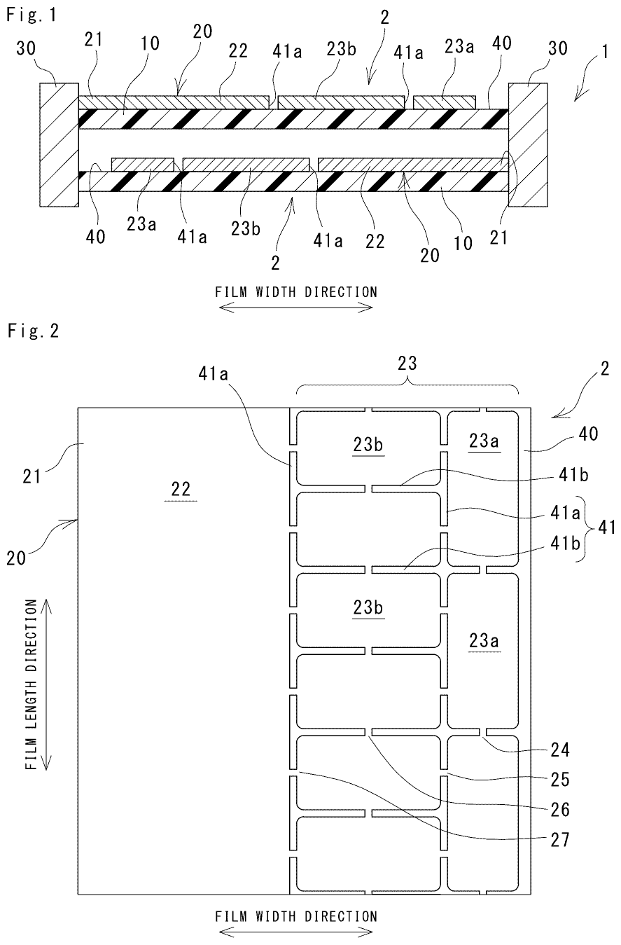

Next, an embodiment of a metallized film 2 of the present invention will be described in detail with reference to the drawings. As illustrated in FIG. 1, the metallized film 2 is obtained by forming a vapor-deposited metal 20, which is formed by vapor-depositing a metal such as aluminum or zinc, on a surface of a dielectric film 10 made of a synthetic resin such as polypropylene (PP) or polyethylene terephthalate (PET). Note that FIG. 1 is a schematic view in which the thicknesses of the dielectric film 10 and the vapor-deposited metal 20 are exaggerated. The actual thicknesses of the dielectric film 10 is, for example, 2 to 3 μm, and the vapor-deposited metal 20 is, for example, 10 to 100 Å, which are extremely thin.

As illustrated in FIG. 2, the vapor-deposited metal 20 is provided up to one end (left end in the drawing) of the dielectric film 10 in a width direction (hereinafter, referred to as a film width direction). However, the vapor-deposited metal 20 is not provided over the entire length of the dielectric film 10 in a length direction (hereinafter, referred to as a film length direction) at the other end (right end in the drawing) in the film width direction. This is for preventing one vapor-deposited metal 20 from being connected to both of two metallikon electrodes 30 provided at the respective ends in the film width direction when a film capacitor 1 is manufactured by superimposing the metallized films 2 (see FIG. 1). Hereinafter, for the sake of explanation, a portion connected to the metallikon electrode 30 on one end side in the film width direction is referred to as a connecting portion 21, and a non-vapor-deposited portion on the other end side in the film width direction is referred to as an insulating margin 40.

The vapor-deposited metal 20 having the above configuration is divided by slit-shaped non-vapor-deposited portions 41. Specifically, the vapor-deposited metal 20 is divided by a plurality of first insulating slits 41a substantially parallel to the film length direction and a plurality of second insulating slits 41b substantially parallel to the film width direction.

Two first insulating slits 41a are provided in the film width direction. The width of the first insulating slit 41a is, for example, 0.05 to 0.5 mm. The width of the first insulating slit 41a is more preferably 0.05 to 0.3 mm. The first insulating slit 41a located in the connecting portion 21 side is provided substantially at the center in the film width direction, and divides the vapor-deposited metal 20 into a connecting portion side electrode 22 and an insulating margin side electrode 23. The other first insulating slit 41a divides the insulating margin side electrode 23 into two in the film width direction. The other first insulating slit 41a is provided not at the center of the first insulating slit 41a on the connecting portion 21 side and the insulating margin 40 but close to the insulating margin 40.

A plurality of second insulating slits 41b is provided in the film length direction. The second insulating slit 41b divides the insulating margin side electrode 23 in the film length direction to form a divided electrode. Note that the connecting portion side electrode 22 is not a divided electrode. The width of the second insulating slit 41b is, for example, 0.05 to 0.5 mm. The width of the second insulating slit 41b is more preferably 0.05 to 0.3 mm. The second insulating slits 41b that reach the insulating margin 40 and that do not reach the insulating margin 40 are provided alternately. As a result, a plurality of first divided electrodes 23a located closest to the insulating margin 40 side and arranged in the film length direction and having a substantially rectangular shape in plan view, and a plurality of second divided electrodes 23b adjacent to the first divided electrodes 23a in the film width direction and having a substantially rectangular shape in plan view are formed. The second divided electrodes 23b are also arranged in the film length direction. Therefore, it can be said that a plurality of the divided electrodes is arranged in the film width direction and in the film length direction. The first divided electrode 23a has a rectangular shape elongated in the film length direction, and the second divided electrode 23b has a rectangular shape elongated in the film width direction. It can be said that the first divided electrode 23a corresponds to the first column as viewed from the insulating margin 40 side, and the second divided electrode 23b corresponds to the second column as viewed from the insulating margin 40 side. This vapor-deposition pattern is continuous in the film length direction.

Any given first divided electrode 23a is adjacent to two first divided electrodes 23a in the film length direction, and is adjacent to two second divided electrodes 23b in the film width direction. Any given first divided electrode 23a is connected to the adjacent first divided electrodes 23a via first fuses 24. In addition, this given first divided electrode 23a is connected to the adjacent second divided electrodes 23b via second fuses 25. In this state, it can be said that four fuses are connected to one first divided electrode 23a. It can also be said that one first divided electrode 23a and all of the divided electrodes (first adjacent electrodes) adjacent to this one first divided electrode 23a in the film width direction and the film length direction are each connected via one fuse.

In addition, any given second divided electrode 23b is adjacent to two second divided electrodes 23b in the film length direction, and is adjacent to the connecting portion side electrode 22 and to one first divided electrode 23a in the film width direction. Any given second divided electrode 23b is connected to the adjacent second divided electrodes 23b via third fuses 26. In addition, this given second divided electrode 23b is connected to the adjacent connecting portion side electrode 22 via a fourth fuse 27. Furthermore, this given arbitrary second divided electrode 23b is connected to the adjacent first divided electrode 23a via the second fuse 25. In this state, it can be said that four fuses are connected to one second divided electrode 23b. It can also be said that one second divided electrode 23b and all of the divided electrodes (second adjacent electrodes) adjacent to this one second divided electrode 23b in the film width direction and the film length direction are each connected via one fuse.

When each length of the outer periphery of the second divided electrodes 23b divided into four parts by a total of four fuses are compared with each other, the second, third, and fourth fuses 25, 26, and 27, respectively, are disposed such that the length of the longest part is less than or equal to three times the length of the shortest part. For example, when the third fuse 26 is disposed substantially at the center of the second divided electrode 23b in the film width direction, and the second fuse 25 and the fourth fuse 27 are disposed substantially at the center of the second divided electrode 23b in the film length direction, the length of the longest part is one time the length of the shortest part, that is, the lengths of the divided outer periphery are equal to each other.

Note that the fuse is not a fuse (so-called corner fuse) provided at the corner (also referred to as a corner portion or a vertex) of the divided electrode but preferably a fuse provided on the side (above the slit) of the divided electrode. In addition, the fuse is to cut off the divided electrode from the current path, and thus the shape of the fuse is not limited as long as such an effect is obtained.

As described above, [2] four or more fuses are connected to one divided electrode, and [3] the divided electrode and all of the divided electrodes adjacent to the divided electrode (adjacent electrodes) are each connected via one fuse, so that the deviation of the positions where the fuses are provided is reduced. Therefore, even if an insulation defect occurs in any part of the divided electrode, it is possible to prevent electric energy required for self-healing from being intensively supplied from a specific fuse. As a result, excessive operation of the fuse can be suppressed.

The area of the first divided electrode 23a is 15 mm² or more. The area of the second divided electrode 23b is also 15 mm² or more. As described above, [1] by setting the area of the divided electrode to 15 mm² or more, all or most of the electric energy required for self-healing can be covered by the divided electrode itself in which the insulating defect has occurred. As a result, the electric energy supplied from another divided electrode via the fuse can be eliminated or reduced. The area of each of the first divided electrodes 23a is 3000 mm² or less, preferably 2000 mm² or less, more preferably 1000 mm² or less, and still more preferably 200 mm² or less. This similarly applies to the second divided electrode 23b.

The widths of the first fuse 24, the second fuse 25, the third fuse 26, and the fourth fuse 27 are, for example, 0.1 to 5 mm. The width is more preferably 0.1 to 0.5 mm.

Next, a comparison between a film capacitor using the metallized film of the present invention (Example 1) and a film capacitor using a conventional metallized film to be compared (Comparative Example 1) will be described.

The metallized film of Example 1 is the metallized film illustrated in FIG. 2, and the material of the dielectric film is polypropylene, the film thickness is 2.8 μm, and the film width is 25 mm. In addition, [1] the areas of the first divided electrode 23a corresponding to the first column and the second divided electrode 23b corresponding to the second column as viewed from the insulating margin side are each 32 mm² and are the same. [2] Four fuses are connected to each of the first divided electrode 23a and second divided electrode 23b. [3] The first divided electrode 23a and all of the divided electrodes (23a, 23b) adjacent to the first divided electrode 23a are each connected via one fuse (24, 25). In addition, the second divided electrode 23b and all of the divided electrodes (23a, 23b) adjacent to the second divided electrode 23b are each connected via one fuse (25, 26). In short, the conditions [1] to [3] are satisfied. The rated voltage of Example 1 is 850 V. The initial electrostatic capacitance is 80 μF.

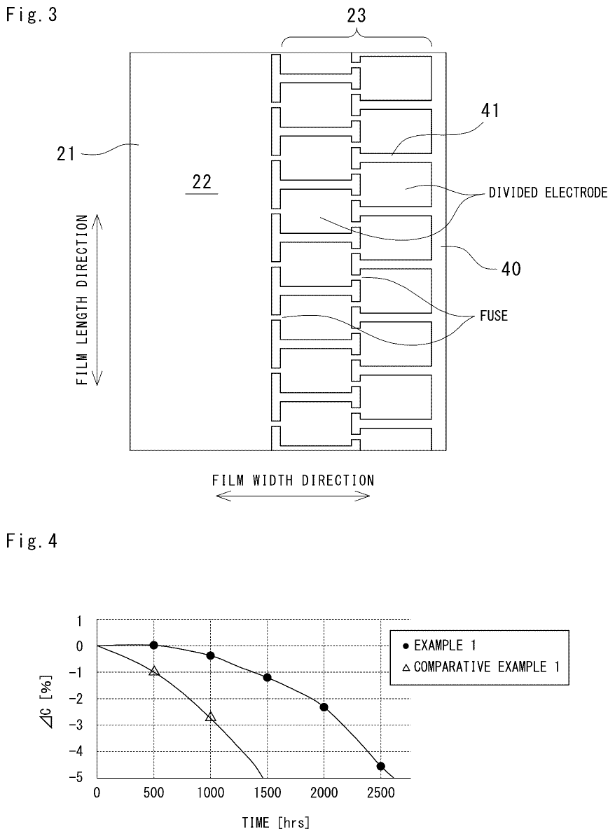

The metallized film of Comparative Example 1 is the metallized film illustrated in FIG. 3, and the material, film thickness, and film width of the dielectric film are the same as those in Example 1. Meanwhile, each of the areas of the divided electrodes corresponding to the first column and the second column as viewed from the insulating margin side is 18mm² . Two fuses are connected to the divided electrode corresponding to the first column as viewed from the insulating margin side, and three fuses are connected to the divided electrode corresponding to the second column as viewed from the insulating margin side. In addition, the divided electrode in the first column and all of the divided electrodes adjacent to the divided electrode are not connected via one fuse (see FIG. 3: the divided electrodes adjacent to each other in the film length direction are not connected via a fuse). Furthermore, the divided electrode in the second column and all of the divided electrodes adjacent to the divided electrode are not connected via one fuse (the divided electrodes adjacent to each other in the film length direction are not connected via a fuse). In short, the conditions [1] to [3] are not satisfied. The fuse width and the fuse length (width of the insulating slit) are the same as those in Example 1. The rated voltage of Comparative Example 1 is 850 V, which is equal to that of Example 1. The initial electrostatic capacitance is 80 μF, which is equal to that of Example 1.

### Life Test

A life test of a capacitor was performed in which the capacitor was placed in a hot air circulation type thermostatic bath set at 105° C., a DC voltage (rated voltage: 850 V) was applied to the capacitor, the capacitor was taken out at a predetermined time (for example, 250 hours, 500 hours, and the like), the capacitor was brought to room temperature and electrical characteristics such as electrostatic capacitance were measured, and the capacitor was placed in the thermostatic bath again to restart the test. The results of Example 1 and Comparative Example 1 are indicated in FIG. 4. As indicated in the drawing, it can be seen that Example 1 has about 1.7 times the life (time until the electrostatic capacitance reaches −5% of the initial electrostatic capacitance) as that of Comparative Example 1. The reason why the capacitance decreased in Example 1 even at the rated voltage is that the generation of the plurality of insulation defects in the same divided electrode caused the current to flow through the fuse a plurality of times, the durability deterioration progressed, and the fuse finally operated.

### Voltage Step-Up Test

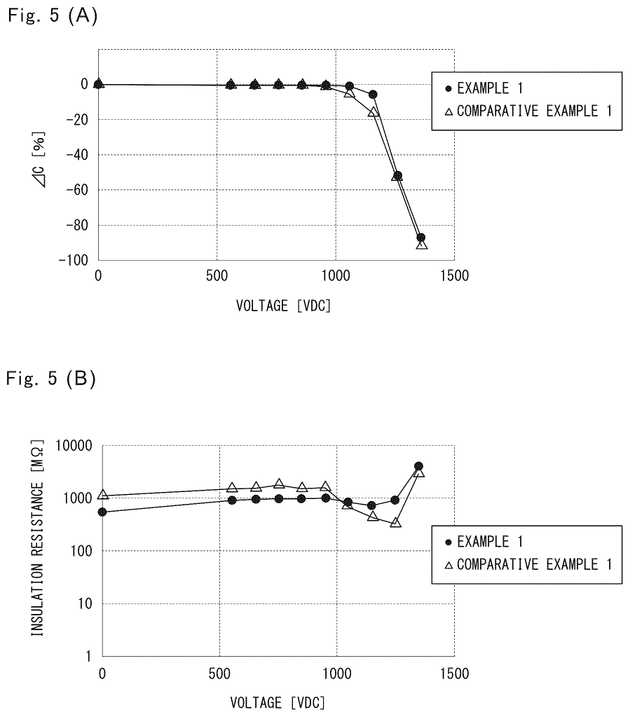

The capacitor was placed in the hot air circulation type thermostatic bath set at 105° C., and a DC voltage of 550 V was applied for 1000 minutes. After the test, the capacitor was brought to room temperature and electrical characteristics such as electrostatic capacitance were measured, the capacitor was placed in the thermostatic bath again, and then the test was performed at 650 V. Thereafter, the test and measurement in which a voltage 100 V higher than the previous step was applied were repeated until the test of 1350 V was completed. The results of Example 1 and Comparative Example 1 are indicated in FIG. 5. As indicated in FIG. 5A, it can be seen that in Comparative Example 1, the electrostatic capacitance decreases from the voltage around 900 V. On the other hand, it can be seen that in Example 1, the decrease in the electrostatic capacitance does not occur up to around 1050 V, and the rate of decrease in the electrostatic capacitance is smaller than that in Comparative Example 1 up to around 1200 V. As indicated in FIG. 5B, in Example 1, the insulation breakdown is not occurred similar to Comparative Example 1, so that it can be seen that the fuse is stably operated also in Example 1.

As described above, in the film capacitor using the metallized film of the present invention, the fuse is operated under an overvoltage region that induces a large insulation defect, and the defect divided electrode is reliably cut off. In addition, insulation is secured by self-healing in an actual use region at a rated voltage or lower at which a large insulation defect hardly occurs. As a result, both safety and securing of electrostatic capacitance can be achieved.

### Relationship Between Heat Generation Amount of Fuse/Heat Generation Amount of Defect Portion and Fuse Operation Rate

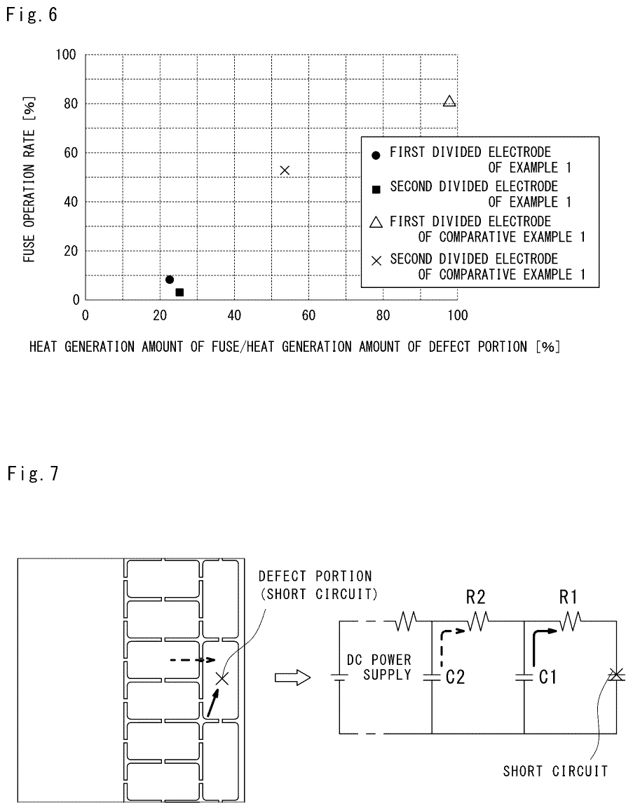

FIG. 6 indicates a relationship between the heat generation amount of a fuse/the heat generation amount of a defect portion and a fuse operation rate. As indicated in the drawing, in Example 1, it can be seen that the heat generation amount of the fuse is 30% or less of the heat generation amount of the defect portion, and the operation rate of the fuse is suppressed to 10% or less. On the other hand, in Comparative Example 1, it can be seen that the heat generation amount of the fuse is about 50 to 80%, which is exceeding 30%, of the heat generation amount of the defect portion, and the operation rate of the fuse is about 50 to 80%, which is exceeding 10%.

Note that the heat generation amount of the fuse and the heat generation amount of the defect portion are calculated by replacing the state in which the defect portion occurred in the divided electrode, with a circuit diagram. Specifically, as illustrated in FIG. 7, the vapor-deposition pattern is first replaced with a circuit including a capacitor C and a resistor R. Then, from a state in which a DC voltage is applied to this circuit by a DC power supply, a current value flowing through each resistor R when a short circuit occurs in the rightmost capacitor in the drawing is obtained. Then, the heat generation amount is calculated from the current value and a resistance value of each resistor R. In FIG. 7, C1 is the electrostatic capacitance of the divided electrode in which the defect portion is formed (hereinafter, referred to as the defect divided electrode). C2 is the electrostatic capacitance of the divided electrode connected to the defect divided electrode via the fuse (hereinafter, referred to as the adjacent divided electrode). R1 is the resistance value of the defect divided electrode itself. R2 is the resistance value of the fuse connecting the defect divided electrode and the adjacent divided electrode. In addition, a solid arrow indicates a current flowing from the inside of the defect divided electrode to the defect portion, and a broken arrow indicates a current flowing from the adjacent divided electrode to the defect divided electrode via the fuse.

### Relationship Between Capacitor Performance (Potential Gradient) and Effective Electrode Area

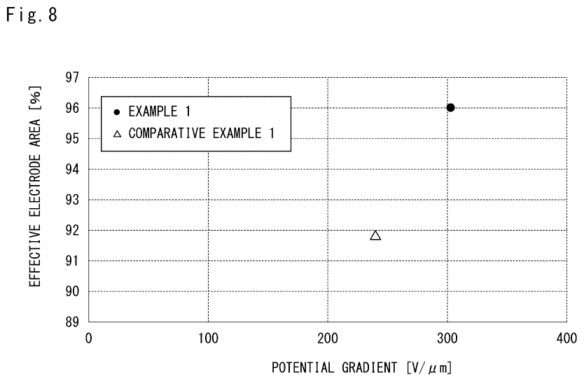

FIG. 8 indicates a relationship between capacitor performance (potential gradient) and an effective electrode area. As indicated in the drawing, when the potential gradient is about 300 V/μm, the effective electrode area (area of the vapor-deposited metal with respect to the area of the dielectric film) is about 96% in Example 1. On the other hand, the effective electrode area is about 92% in Comparative Example 1, and it can be seen that miniaturization can be achieved in Example 1 as compared with Comparative Example 1 in the same electrostatic capacitance.

Although specific embodiment of the present invention has been described above, the present invention is not limited to the above embodiment, and various modifications can be made within the scope of the present invention.

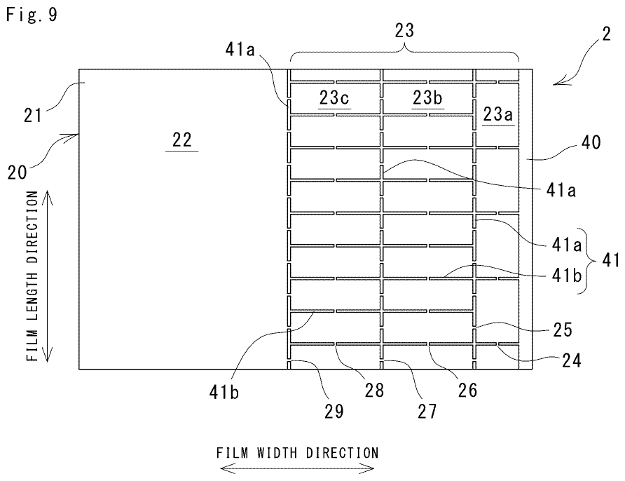

For example, in the metallized film 2 illustrated in FIG. 2, the divided electrodes are provided only up to the second column as viewed from the insulating margin 40 side, but the third and subsequent columns may be provided. For example, by providing three or more first insulating slits 41a, divided electrodes of the third and subsequent columns can be formed. In FIG. 9, three first insulating slits 41a are provided (N=3). Thus, third (N-th) divided electrodes 23c of the third (N-th) column are formed. In addition, all of divided electrodes adjacent to the third (N-th) divided electrode 23c (third (N-th) adjacent electrode) in the film width direction and the film length direction are defined. A fifth fuse 28 that connects the third divided electrodes 23c adjacent to each other in the film length direction, and a sixth fuse 29 that connects the third divided electrode 23c and a connecting portion side electrode 22 are formed. Not only a first divided electrode 23a and a second divided electrode 23b but also the third (N-th) divided electrode 23c satisfies the above conditions [1] to [3]. Specifically, [1] the area is 15 mm² or more, [2] four or more fuses (27, 28, 29) are connected, and [3] all of the adjacent divided electrodes (all of the third (N-th) adjacent electrodes) are each connected via one fuse (27, 28). In short, all of the divided electrodes satisfy the above conditions [1] to [3]. Therefore, also in a metallized film 2 in FIG. 9, excessive operation of the fuse can be suppressed similarly to the metallized film 2 in FIG. 2.

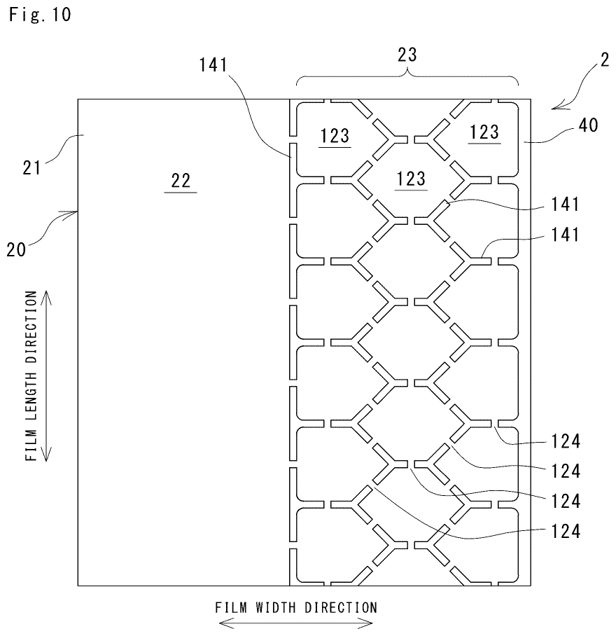

In addition, the number of fuses connected to one divided electrode is four, but may be five or more. For example, as illustrated in FIG. 10, as viewed from an insulating margin 40 side, an insulating margin side electrode 23 may be divided by insulating slits 141 such that the shapes of divided electrodes 123 become a pentagonal shape in the first column, a hexagonal shape in the second column, and a pentagonal shape in the third column, and the number of fuses 124 may be changed to four in the first column, six in the second column, and five in the third column. Note that, in a metallized film 2 in FIG. 10, the insulating margin side electrode 23 is divided in the film width direction by the oblique insulating slits 141. In other words, the oblique insulating slits 141 function as the first insulating slits 41a.

A connecting portion side electrode 22 may be divided, for example, at fixed intervals in the film length direction. Note that a vapor-deposited metal sandwiched between the slit (specifically, the first insulating slit 41a) dividing in the film width direction and the insulating margin 40 is a “divided electrode”, and even when the connecting portion side electrode 22 is divided in the film length direction, the electrode is not a “divided electrode”.

As a connecting portion 21, a so-called heavy edge using a vapor-deposited metal thicker than the divided electrode may be adopted. As a method for superimposing a plurality of metallized films 2, other than simply stacking the metallized films 2, the metallized films 2 may be superimposed by winding. In addition, the film capacitor may be formed by superimposing a double-sided metallized film obtained by forming vapor-deposited metal 20 on both surfaces of one dielectric film 10, and the dielectric film 10. Furthermore, metallized films having the same vapor-deposition pattern do not necessarily need to be superimposed, and a film capacitor may be formed by combining metallized films having different vapor-deposition patterns.

In addition, the metallized film of the present invention also includes a metallized film having the following configuration.

A metallized film that includes: a dielectric film; a divided electrode vapor-deposited on the dielectric film; an insulating margin formed along one end of the dielectric film in a width direction; and a fuse, in which the divided electrodes are aligned in the width direction and a length direction of the dielectric film, and when the divided electrode located in a first column as viewed from a side of the insulating margin is a first divided electrodes, a divided electrode adjacent to the first divided electrode is a first adjacent electrode, a divided electrode located in a second column as viewed from the insulating margin side is a second divided electrode, and a divided electrode adjacent to the second divided electrode is a second adjacent electrode, the first divided electrode satisfies all of the following conditions [1], [2], and [3A], and the second divided electrode satisfies all of the following conditions [1], [2], and [3B].
[1] An area is 15 mm² or more.
[2] Four or more of the fuses are connected.
[3A] It is connected to all of the first adjacent electrodes, each via one of the fuses.
[3B] It is connected to all of the second adjacent electrodes, each via one of the fuses.

Reference Signs List
1 Film capacitor
2 Metallized film
10 Dielectric film
20 Vapor-deposited metal
21 Connecting portion
22 Connecting portion side electrode
23 Insulating margin side electrode
23a First divided electrode
23b Second divided electrode
23c Third divided electrode
24 First fuse
25 Second fuse
26 Third fuse
27 Fourth fuse
28 Fifth fuse
29 Sixth fuse
30 Metallikon electrode
40 Insulating margin
41 Non-vapor-deposited portion
41a First insulating slit
41b Second insulating slit
123 Divided electrode
124 Fuse
141 Insulating slit

1: A metallized film obtained by vapor-depositing a metal on a dielectric film such that an insulating margin is formed on one end of the dielectric film in a width direction, the metallized film comprising:
a divided electrode formed by dividing a vapor-deposited metal on a side of the insulating margin by slit-shaped non-vapor-deposited portions; and
a fuse connected to the divided electrode,
wherein a plurality of the divided electrodes is arranged in the width direction of the dielectric film, and
the divided electrodes corresponding to a first column and a second column as viewed from the insulating margin side satisfy all of the following conditions [1] to [3]:
[1] An area is 15 mm² or more;
[2] Four or more of the fuses are connected; and
[3] It is connected to all adjacent divided electrodes, each via one of the fuses.

2: The metallized film according to claim 1, wherein all of the divided electrodes satisfy all of the conditions [1] to [3].

3: A film capacitor using the metallized film according to claim 1.
